(19) United States
(12) Patent Application Publication
(10) Pub. No.: US 2015/0143824 A1
(43) Pub. Date: May 28, 2015

(54) ICE CREAM FREEZER BURN PREVENTION METHOD AND APPARATUS

(71) Applicant: Dan Blessing, Killen, AL (US)

(72) Inventor: Dan Blessing, Killen, AL (US)

(21) Appl. No.: 14/268,719

(22) Filed: May 2, 2014

Related U.S. Application Data
(60) Provisional application No. 61/909,320, filed on Nov. 26, 2013.

(51) Int. Cl. A23G 9/22

(52) U.S. Cl. CPC A23G 9/225
USPC 62/60

(57) ABSTRACT

An ice cream freezer burn prevention method and apparatus is provided. The device of the present invention includes a flexible pouch with a non-freezing solution within. The flexible pouch is placed over ice cream within a container after a portion of the ice cream has been removed. The flexible pouch conforms to the ice cream and preserves the ice cream as well as preventing freezer burn.

### CROSS-REFERENCE TO RELATED APPLICATION

This application claims the benefit of priority of U.S. provisional application No. 61/909,320, filed Nov. 26, 2013, the contents of which are herein incorporated by reference.

### BACKGROUND OF THE INVENTION

The present invention relates to food storage accessories and, more particularly, to a method and apparatus for preventing freezer burn when storing ice cream in the freezer.

Ice cream is a frozen dessert usually made from dairy products, such as milk and cream and often combined with fruits or other ingredients and flavors.

Ice cream is typically stored and sold in containers. After a container of ice cream is opened, it rapidly succumbs to freezer burn due to exposure to air. The ice cream product is quickly ruined due to poor taste or crystallization.

As can be seen, there is a need for a device that can prevent freezer burn of ice cream, especially when storing ice cream after a portion of the ice cream is removed from the container.

### SUMMARY OF THE INVENTION

In one aspect of the present invention, a method for prevent food degradation of ice cream, comprises: providing a flexible pouch comprising a non-freezing solution within the flexible pouch; removing a lid from an ice cream container; and placing the flexible pouch over ice cream in the ice cream container after a portion of the ice cream has been removed.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a perspective view of the present invention;

FIG. 3 is an exploded view of the present invention;

FIG. 4 is a section view of the present invention taken along line 4-4 in FIG. 1;

FIG. 5 is a perspective view of an alternate embodiment of the present invention shown in use; and

FIG. 6 is an exploded view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an ice cream freezer burn prevention method and apparatus. The device of the present invention includes a flexible pouch with a non-freezing solution within. The flexible pouch is placed over ice cream within a container after a portion of the ice cream has been removed. The flexible pouch conforms to the ice cream and preserves the ice cream as well as preventing freezer burn.

The present invention includes a method and apparatus for protecting ice cream from freezer burn, such as after a portion of the ice cream is removed from the container. The container is then placed back in the freezer for storage. The device may easily and rapidly provide a secure covering on the top of any ice cream within the ice cream container to isolate the ice cream from air exposure, thus stopping the process of air exposure and, thus, freezer burn, crystallization, or other associated problems.

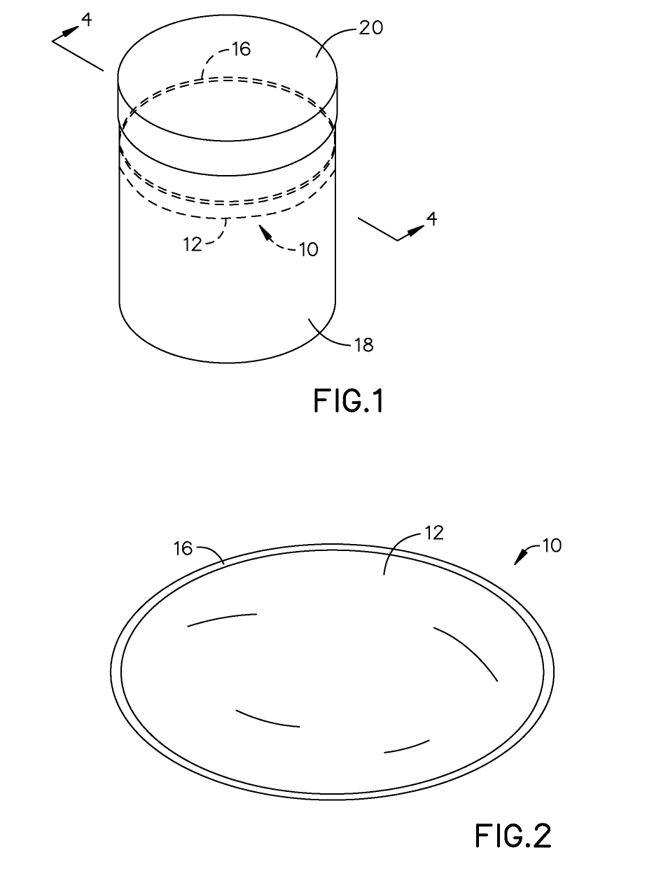

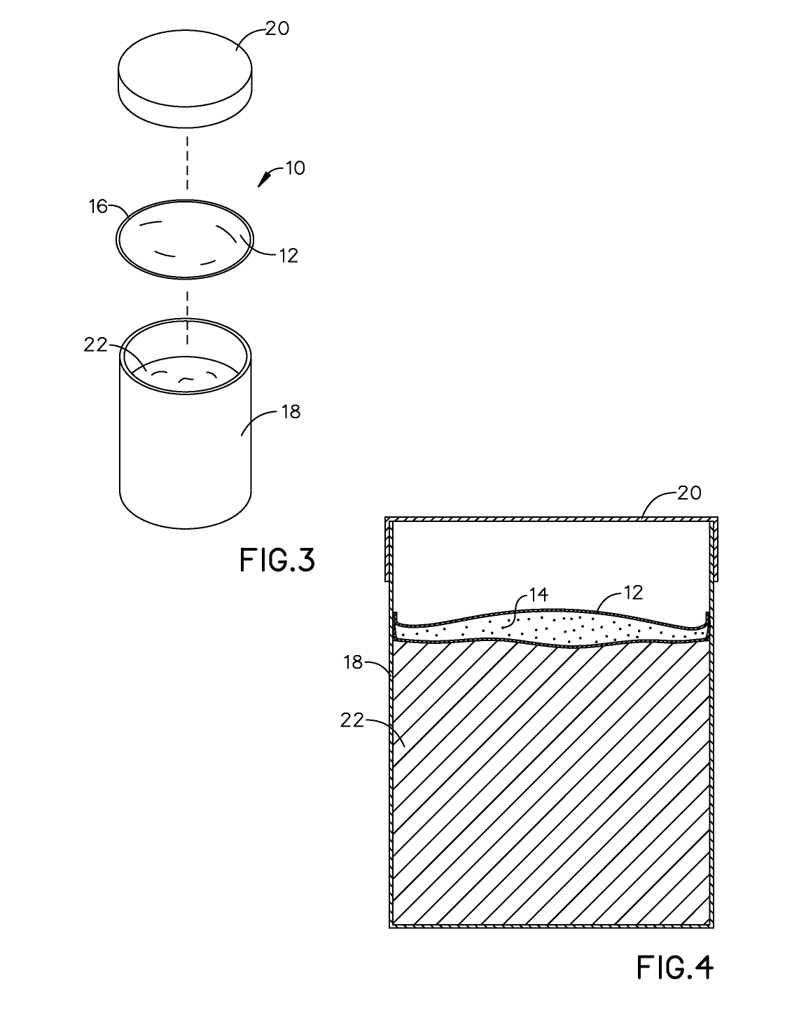

Referring to FIGS. 1 through 6, a device 10 is provided that includes a saline or other reduced freezing point solution within a safe and flexible space filling material. The non-freezing solution 14 may include a solution that does not freeze when placed in typical freezer temperatures, such as 0° F. The non-freezing solution 14 can be disposed in a flexible pouch 12. The flexible pouch 12 may be made from rubber, silicone or other similar material that is suitable for contact with food.

To remove ice cream 22 from a container 18, the lid 20 is removed, and the ice cream 22 is scooped out. The lid 20 is then placed back onto the container 18, and the resulting air space in between the lid 20 and the ice cream 22 can cause food quality degradation when the container 18 is placed back in the freezer. The device 10 of the present invention can be placed on the top of the ice cream 22 in the container 18 and can shape itself to the shape of the removed ice cream, removing any gap, opening or area in the container 18. The present invention can block the ice cream 22 from exposure to air while stored in the freezer, thus stopping freezer burn and food contamination.

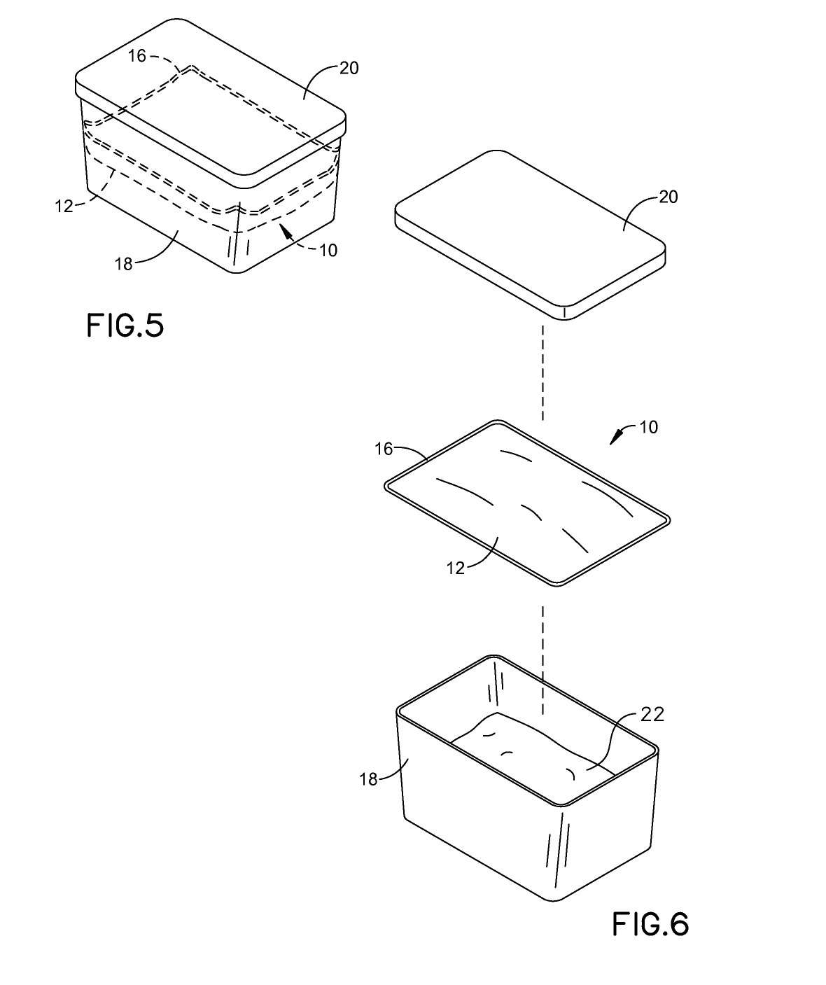

The flexible pouch 12 containing the non-freezing solution 14 can be formed as a pre-sealed, pre-sized pouch 12. In certain embodiments, the pouch 12 may be shaped to mimic the shape of the ice cream container. For example, the flexible pouch 12 may be circular, as illustrated in FIGS. 1 through 4. Alternatively, the flexible pouch 12 may be rectangular or square shaped, as illustrated in FIGS. 5 and 6.

The flexible pouch 12 may include an upper cover, a lower cover and a seam 16 connecting the outer edges of the upper cover and the lower cover together. The seam 16 may be around the perimeter of the flexible pouch 12. In certain embodiments, the flexible pouch may include a closable opening to add the non-freezing solution 14 and in other embodiment, the container can be pre-filled with the non- freezing solution 14. In certain embodiments, the pouch 12 may be made in various sizes so that a smaller size may be used when only a small amount of ice cream 22 is removed from the ice cream container 18, but a larger size may be used when the ice cream container 18 is closer to being empty.

It should be understood, of course, that the foregoing relates to exemplary embodiments of the invention and that modifications may be made without departing from the spirit and scope of the invention as set forth in the following claims.

What is claimed is:

1. A method for prevent food degradation of ice cream, comprising:
providing a flexible pouch comprising a non-freezing solution within the flexible pouch; and
placing the flexible pouch over an ice cream in an ice cream container; and
placing the ice cream container in a freezer.

2. The method of claim 1, further comprising the step of filling any air spaces disposed about the ice cream with the flexible container.

3. The method of claim 1, further comprising the steps of:
removing a lid from an ice cream container; and
placing the flexible pouch over ice cream in an ice cream container after a portion of the ice cream has been removed

4. The method of claim 1, further comprising closing the lid of the ice cream container.

5. The method of claim 1, wherein the flexible pouch comprises an upper cover comprising an outer edge, a lower cover comprising an outer edge, and a seam connecting the outer edges of the upper cover and the lower cover together

6. The method of claim 1, wherein the non-freezing solution is a saline solution.

7. The method of claim 1, wherein the flexible pouch comprises a shape conforming to an opening of the ice cream container.

8. The method of claim 6, wherein the shape is rectangular or circular.
